(19) United States
(12) Patent Application Publication
(10) Pub. No.: US 2010/0182414 A1
(43) Pub. Date: Jul. 22, 2010

(54) IMAGE PROCESSOR, SCOPE, AND ENDOSCOPE APPARATUS INCLUDING THE SAME

(76) Inventor: Hiroshi SUZUKI, Tokyo (JP)

Correspondence Address: OSTROLENK FABER GERB & SOFFEN, 1180 AVENUE OF THE AMERICAS, NEW YORK, NY, 100368403, US

(21) Appl. No.: 12/628,497

(22) Filed: Dec. 1, 2009

Related U.S. Application Data
(63) Continuation of application No. PCT/JP2008/060394, filed on Jun. 5, 2008.

(30) Foreign Application Priority Data
Jun. 8, 2007 (JP) 2007-152952

(51) Int. Cl. H04N 7/18

(52) U.S. Cl. 348/71; 348/E07.085

(57) ABSTRACT

An image processor effects a color conversion appropriate for an image acquisition unit, such as a scope, and improves color reproduction accuracy. The image processor includes a plurality of color conversion sections; an information acquisition section that acquires an index for selecting at least one of the plurality of color conversion sections as a specific color conversion means for applying a color conversion process to an input video signal; and a selection section that selects at least one of the plurality of color conversion sections as the specific color conversion means based on the index, in which the plurality of color conversion sections include a linear color conversion section that applies a color conversion process based on linear conversion to the input video signal. A table conversion section applies a color conversion process to the input video signal, based on nonlinear conversion.

### CROSS REFERENCE TO RELATED APPLICATIONS

This application is a continuation application of PCT/JP2008/060394 filed on Jun. 5, 2008 and claims benefit of Japanese Application No. 2007-152952 filed in Japan on Jun. 8, 2007, the contents of which is hereby incorporated by its reference.

### BACKGROUND OF THE INVENTION

1. Field of the Invention

The present invention relates to an image processor for applying a color conversion process to color signals, a scope, and an endoscope apparatus including the same.

2. Description of Related Art

In endoscope apparatuses, a scope having an image acquisition device is connected to a processor main unit, and the scope is inserted into a body and acquires an image of a subject to obtain a video signal. Various types of scopes are used for endoscope apparatuses depending on the intended image-acquisition use, and their characteristics are different depending on the type of scope, such as the spectral sensitivity characteristic of a CCD or the spectral transmission characteristic of a color filter disposed in front of a CCD. Therefore, color reproduction of an acquired image is different depending on the type of scope. Color reproduction is a critical issue particularly in clinical settings where endoscope apparatuses are used.

Technologies for eliminating such differences in color reproduction and aimed at providing the same color reproduction among a plurality of different models of scopes include a color management system (hereinafter, referred to as “CMS”). In the CMS for conventional endoscope apparatuses, a color conversion process is performed by applying, in a processor, matrix conversion to a video signal output from a scope. At this time, conversion coefficients appropriate for the type of scope are written in a memory included in the processor. For example, Japanese Unexamined Patent Application, Publication No. Sho-62-199190 describes a technology in which an ID is held in a scope, color correction data appropriate for the ID is read from a memory when the scope is connected to a processor main unit, and a color correction process is performed based on the color correction data. Furthermore, Japanese Unexamined Patent Application, Publication No. 2001-70240 describes a technology for controlling a color correction matrix depending on a scope, to perform a color correction process.

In Japanese Unexamined Patent Application, Publication No. Sho-62-199190 and Japanese Unexamined Patent Application, Publication No. 2001-70240, since the color correction process is performed by using color correction data appropriate for a scope, an appropriate color correction process can be adaptively performed for each type of scope.

### BRIEF SUMMARY OF THE INVENTION

According to a first aspect, the present invention provides an image processor including: a plurality of color conversion sections; an information acquisition section that acquires an index for selecting at least one of the plurality of color conversion sections as a specific color conversion means for applying a color conversion process to an input video signal; and a selection section that selects the at least one of the plurality of color conversion sections as the specific color conversion means, based on the index, in which the plurality of color conversion sections include a linear color conversion section that applies a color conversion process based on linear conversion to the input video signal and a nonlinear color conversion section that applies a color conversion process based on nonlinear conversion to the input video signal.

According to a second aspect, the present invention provides a scope that is detachably attached to one of the above-described image processors and that accommodates a recording medium having the index recorded therein.

### BRIEF DESCRIPTION OF THE SEVERAL VIEWS OF THE DRAWINGS

FIG. 1 is a functional block diagram showing, in expanded fashion, the functions of an endoscope apparatus according to a first embodiment of the present invention.

FIG. 2 is an explanatory diagram of a color-difference line-sequential complementary color filter of the endoscope apparatus shown in FIG. 1.

FIG. 3 is a diagram of a first configuration of a color conversion section of the endoscope apparatus shown in FIG. 1.

FIG. 4 is a diagram of a second configuration of the color conversion section of the endoscope apparatus shown in FIG. 1.

FIG. 5 is a configuration diagram of a determination section shown in FIG. 3.

FIG. 6 is a diagram of a third configuration of the color conversion section of the endoscope apparatus shown in FIG. 1.

FIG. 7 is a flowchart of a color conversion process performed in the endoscope apparatus shown in FIG. 1.

FIG. 8 is a functional block diagram showing, in expanded fashion, the functions of an endoscope apparatus according to a second embodiment of the present invention.

FIG. 9 is a diagram of a first configuration of a color conversion section of the endoscope apparatus shown in FIG. 8.

FIG. 10 is an explanatory diagram of a processing method table ROM shown in FIG. 9.

FIG. 11 is a diagram of a second configuration of the color conversion section of the endoscope apparatus shown in FIG. 8.

### DETAILED DESCRIPTION OF THE INVENTION

### First Embodiment

An image processor, a scope, and an endoscope apparatus including the same according to a first embodiment of the present invention will be described below with reference to the drawings.

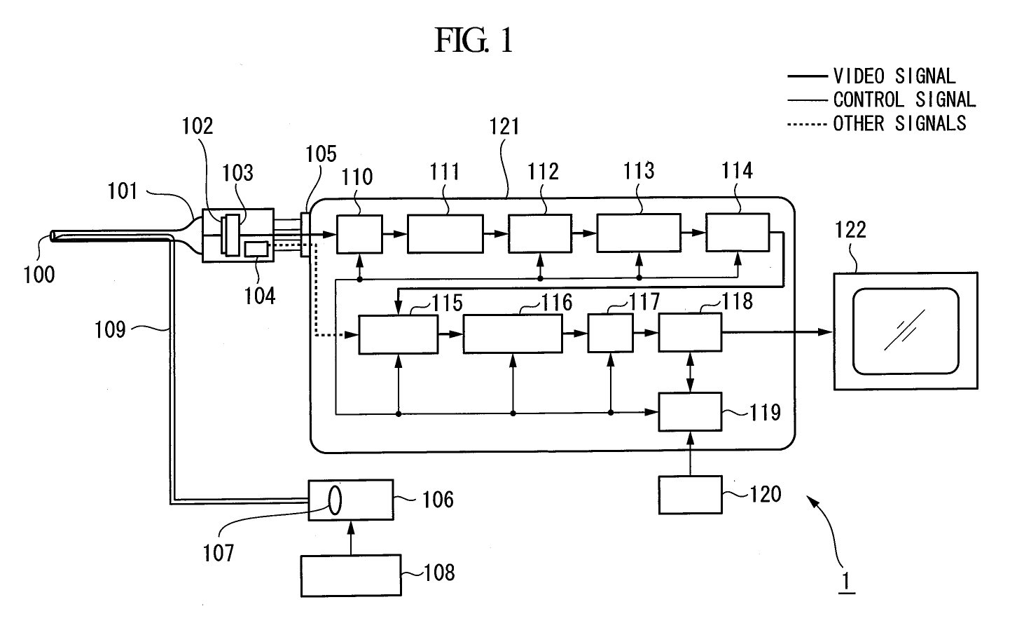

FIG. 1 is a functional block diagram showing, in expanded fashion, the functions of the endoscope apparatus according to this embodiment.

An endoscope apparatus 1 includes, as main components, a processor section (image processor) 121 that applies image processing to input images and a scope (image acquisition unit) 101 that is detachably attached to the processor section 121 and that includes an image acquisition device.

The scope 101 accommodates a lens system 100, a color filter 102, a CCD 103, and a memory (recording medium) 104 that stores an ID number for identifying a color conversion processing method for the model of each scope 101 and other data.

Furthermore, the scope 101 is connected to a light source section 106 by a light guide 109. The light source section 106 has a lamp 107 and emits light having a light level specified by a light-level control section 108.

The processor section 121 includes an A/D 110, a buffer 111, an interpolation section 112, a Y/C separation section 113, a WB section 114, a color conversion section 115, a signal processing section 116, a D/A 117, an output section 118, and a control section 119.

The A/D 110, which is connected to the scope 101 via a connecting section 105, is connected to the buffer 111. The buffer 111 is connected to the interpolation section 112, and the interpolation section 112 is connected to the Y/C separation section 113. In addition, the Y/C separation section 113 is connected to the WB section 114. Furthermore, the WB section 114 is connected to the color conversion section 115, and the color conversion section 115 is connected to the signal processing section 116. The signal processing section 116 is connected to the D/A 117, and the D/A 117 is connected to the output section 118. The output section 118 is connected to an external display unit 122.

Furthermore, the control section 119, which is a microcomputer, for example, is bi-directionally connected to the A/D 110, the interpolation section 112, the Y/C separation section 113, the WB section 114, the color conversion section 115, the signal processing section 116, the D/A 117, and the output section 118. A power switch and an input section 120 that is used by a user to switch various settings for photographing are also bi-directionally connected to the control section 119.

The operation of the thus-configured endoscope apparatus 1 will be described below.

First, a color mode is specified by the user via the input section 120, and the level of light from the light source is specified in the light-level control section 108. Then, the lamp 107 included in the light source section 106 emits light, and the light is supplied to the scope 101 via the light guide 109 to irradiate a subject. A video of the subject irradiated with the light in this way is acquired by the scope 101 and is sent to the processor section 121 as a video signal.

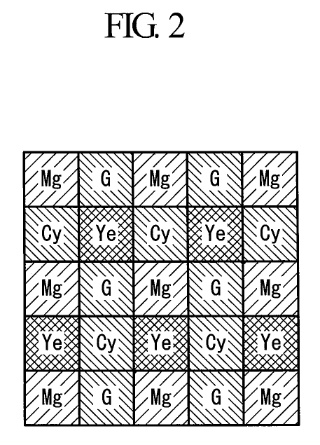

Note that, in this embodiment, is it assumed that the image acquisition system is a single-plane CCD in front of which a color-difference line-sequential complementary color filter is disposed. In a color-difference line-sequential system, 2×2 pixels are handled as a base unit, and Cy (cyan), Mg (magenta), Ye (yellow), and G (green) are arrayed at the respective pixels, as shown in FIG. 2. However, the positions of Cy and Ye are reversed in each line in this embodiment. Furthermore, in this embodiment, the bit length of the digitized video signal is 12 bits, for example.

The flow of the video signal in the processor section 121 will be described below.

The video signal acquired by the scope 101 is sent to the A/D 110, the buffer 111, the interpolation section 112, the Y/C separation section 113, the WB section 114, and the color conversion section 115, in that order, and is subjected to a color conversion process in the color conversion section 115. The video signal that has been subjected to the color conversion process in the color conversion section 115 is sent to the signal processing section 116, the D/A 117, and the output section 118, in that order, and is output by the output section 118 to the display unit 122.

Video signal processing performed in the processor section 121 will be described below in detail.

The video signal that has been converted into a digital signal in the A/D 110 is sent to the interpolation section 112 via the buffer 111. In the interpolation section 112, a four-plane video signal to which a known interpolation process has been applied is generated and transferred to the Y/C separation section 113. The Y/C separation section 113 calculates luminance and color-difference signals from the video signal obtained via the interpolation section 112. The luminance and color-difference signals are calculated for each pixel, as in Equation (1).

$$[ \begin{matrix}{Y}_{i} \\ {CB}_{i} \\ {Cr}_{i}\end{matrix} ] = [ \begin{matrix}{m}_{1} & {m}_{2} & {m}_{3} & {m}_{4} \\ {m}_{5} & {m}_{6} & {m}_{7} & {m}_{8} \\ {m}_{9} & {m}_{10} & {m}_{11} & {m}_{12 }\end{matrix} ] [ \begin{matrix}{Cy}_{i} \\ {Mg}_{i} \\ {Ye}_{i} \\ {G}_{i}\end{matrix} ] \qquad ( 1 )$$

wherein i indicates the coordinate of a pixel, and m₁ to m₁₂ indicate matrix coefficients used to convert Cy, Mg, Ye, and G signals into Y, Cb, and Cr signals. This calculation is performed for all pixels. The YCbCr signals calculated by Equation (1) are transferred to the WB section 114.

The WB section 114 performs a white balance process by multiplying the color-difference signals Cb and Cr by predetermined white-balance coefficients. The YCbCr signals obtained after the white balance process are transferred to the color conversion section 115. The color conversion section 115 determines a color conversion processing method appropriate for the scope 101 based on an ID number that is recorded in the memory 104 included in the scope 101 and that identifies the color conversion processing method for each scope 101, and applies a color conversion process to the YCbCr signals.

The YCbCr signals that have been subjected to the color conversion process are transferred to the signal processing section 116. The signal processing section 116 converts the YCbCr signals into RGB signals through a known color space conversion process, further applies a known gradation conversion process, a known edge enhancement process, etc. to the RGB signals, and transfers them to the D/A 117. The D/A 117 converts the RGB signals obtained via the signal processing section 116 into analog signals and transfers the converted RGB signals to the output section 118. The output section 118 displays the RGB signals obtained via the D/A 117, on the display unit 122.

The color conversion process performed in the color conversion section 115 will be described below in detail.

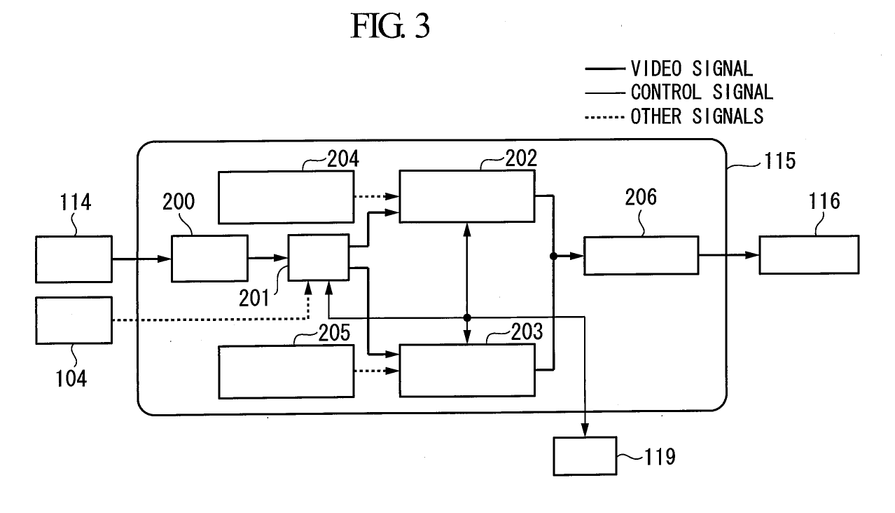

FIG. 3 is a functional block diagram showing a first configuration example of the color conversion section 115.

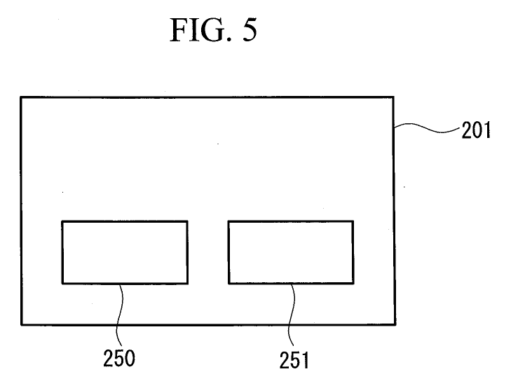

As shown in FIG. 3, the color conversion section 115 includes a buffer 200, a determination section 201, a linear matrix conversion section (linear color conversion section) 202, a table conversion section (nonlinear color conversion section) 203, a linear matrix coefficient ROM 204, a table coefficient ROM 205, and an image buffer 206. As shown in FIG. 5, the determination section 201 has an information acquisition section 250 and a selection section 251.

The buffer 200 connected to the WB section 114 is connected to the determination section 201, which is connected to the memory 104. The determination section 201 is connected to the linear matrix conversion section 202 and the table conversion section 203. The linear matrix coefficient ROM 204 is connected to the linear matrix conversion section 202, and the table coefficient ROM 205 is connected to the table conversion section 203. Also, the linear matrix conversion section 202 and the table conversion section 203 are connected to the image buffer 206. Furthermore, the image buffer 206 is connected to the signal processing section 116.

Note that the control section 119 is bi-directionally connected to the determination section 201, the linear matrix conversion section 202, and the table conversion section 203.

YCbCr signals transferred from the WB section 114 are temporarily stored in the buffer 200 and are transferred to the determination section 201. Further, the ID number recorded in the memory 104 included in the scope 101 is transferred to the determination section 201. In the determination section 201, a color conversion processing method is determined based on the ID number obtained via the memory 104. The color conversion processing method is determined by using Equation (1-1), for example.

$$\{ \begin{matrix}if & ID = 1 method 1 \\ if & ID = 2 method 2\end{matrix} \qquad ( 1 \text{-} 1 )$$

wherein method1 and method2 indicate predetermined different color conversion processing methods. In this embodiment, it is assumed that method1 indicates a color conversion processing method based on linear matrix conversion and method2 indicates a color conversion processing method based on table conversion, for example. The determination section 201 transfers the YCbCr signals transferred from the buffer 200 to the linear matrix conversion section 202 when the ID number is 1, and transfers the YCbCr signals to the table conversion section 203 when the ID number is 2.

First, a description will be given below of a case where the ID number is 1, that is, a case where a linear color conversion process is performed.

The linear matrix conversion section 202 reads, for each pixel, YCbCr signals transferred from the determination section 201 and performs linear matrix conversion shown in Equation (2).

$$[ \begin{matrix}{Y}_{i}^{′} \\ {Cb}_{i}^{′} \\ {Cr}_{i}^{′}\end{matrix} ] = [ \begin{matrix}{a}_{1} & {a}_{2} & {a}_{3} \\ {a}_{4} & {a}_{5} & {a}_{6} \\ {a}_{7} & {a}_{8} & {a}_{9}\end{matrix} ] [ \begin{matrix}\begin{matrix}{Y}_{i} \\ {Cb}_{i}\end{matrix} \\ {Cr}_{i}\end{matrix} ] \qquad ( 2 )$$

wherein Yᵢ, Cbᵢ, and Crᵢ indicate input YCbCr signals of pixel i, and Yᵢ′, Cbᵢ′, Crᵢ′ indicate YCbCr signals of pixel i obtained after the linear matrix conversion. Further, a₁ to a₉ indicate linear matrix coefficients.

The linear matrix coefficient ROM 204 records linear matrix coefficients in advance, and the linear matrix conversion section 202 reads predetermined linear matrix coefficients from the linear matrix coefficient ROM 204 and performs the linear matrix conversion. The linear matrix conversion is performed with the aim of providing color reproduction that is the same as that of the target scope, and functions to reduce numerical errors with respect to the target YCbCr signals. The difference in color reproduction between scopes is caused because the spectral characteristics of image acquisition devices included in the scopes are different. Therefore, it is possible to come close to the target color reproduction by calculating linear matrix coefficients that eliminate the difference between the spectral characteristics of the two image acquisition devices included in the scope that provides the target color reproduction and in the scope that is subjected to the color conversion process, and by applying the linear matrix conversion to the luminance and color-difference signals output from the scope to be processed. Thus, for example, the linear matrix coefficients are calculated by using the least-squares method such that the numerical square error becomes minimum at each wavelength between the target spectral characteristic and the spectral characteristic obtained after the linear matrix conversion. Here, the matrix coefficients a₁ to a₉ that minimize E of Equation (3) are calculated by the least-squares method. Note that the range of Σ for λ is specified from 380 to 780 nm; the range of λ can be changed as desired.

$${\sum }_{λ} {( [ \begin{matrix}S {1}_{Y} ( λ ) \\ S {1}_{C b} ( λ ) \\ S {1}_{C r} ( λ )\end{matrix} ] - [ \begin{matrix}{a}_{1} & {a}_{2} & {a}_{3} \\ {a}_{4} & {a}_{5} & {a}_{6} \\ {a}_{7} & {a}_{8} & {a}_{9}\end{matrix} ] [ \begin{matrix}S {2}_{Y} ( λ ) \\ S {2}_{Cb} ( λ ) \\ S {2}_{Cr} ( λ )\end{matrix} ] )}^{2} \qquad ( 3 )$$

wherein S1_{Y}(A), S2_{Cb}(λ), and S1_{Cr}(λ) indicate the spectral characteristics of the Y signal, the Cb signal, and the Cr signal of the image acquisition device that provides the target color reproduction. Further, S2_{Y}(λ), S2_{Cb}(λ), and S2_{Cr}(λ) indicate the spectral characteristics of the Y signal, the Cb signal, and the Cr signal of the image acquisition device that is subjected to the color conversion process.

The YCbCr′ signals to which the linear matrix conversion has been applied as described above are transferred to the image buffer 206. After the linear matrix conversion is applied to the YCbCr signals of all pixels, the YCbCr′ signals stored in the image buffer 206 are transferred to the signal processing section 116.

Next, a description will be given below of a case where the ID number is 2, that is, a case where a table conversion process is performed.

The table conversion section 203 reads, for each pixel, the YCbCr signals transferred from the determination section 201 and applies a color conversion process thereto with reference to table coefficients recorded in the table coefficient ROM 205 based on a combination of the YCbCr signals of each pixel.

The table coefficient ROM 205 records, in advance, an associated relationship between input YCbCr signals and output YCbCr′ signals. The table coefficients can be obtained, for example, by applying nonlinear matrix conversion that handles high-order terms of Y, Cb, and Cr signals, in addition to the linear matrix conversion shown in Equation (2), to each combination of Y, Cb, and Cr signals and by generating a table in which the input Y, Cb, and Cr signals and the converted Y, Cb, and Cr signals are associated in a one-to-one manner.

Further, it is also possible to generate the table by associating with each other the video signals for each of predetermined color charts, acquired and output from an image acquisition unit providing the target color reproduction and an image acquisition unit subjected to the color conversion process.

The YCbCr′ signals converted by the table conversion section 203 are transferred to the image buffer 206 and are stored therein. After the color conversion process is applied to YCbCr signals of all pixels, the YCbCr′ signals stored in the image buffer 206 are transferred to the signal processing section 116.

As described above, according to the endoscope apparatus of this embodiment, it is possible to select at least one of the linear matrix conversion section 202 and the table conversion section 203 based on an index obtained by the determination section 201 and to apply the color conversion process to an input video signal using the selected color conversion processing method. Further, by selecting specific color conversion means based on the index previously set in each scope, a color conversion process appropriate for the characteristics of the scope can be performed.

Note that, in the above-described embodiment, a configuration is used in which the memory 104 is accommodated in the scope 101 and the determination section 201 reads an index with the scope 101 attached to the processor section 121; however, the configuration for reading an index is not limited to this example. For example, a configuration may be used in which an external interface (not shown) to which a recording medium that records an index for the scope in advance is detachably connected is provided on the processor section 121 and, when the recording medium is connected to the external interface, the determination section reads the index from the recording medium. The recording medium needs to be a computer-readable medium and can be, for example, a USB memory, an SD memory, a flash memory, a CD-ROM, or the like.

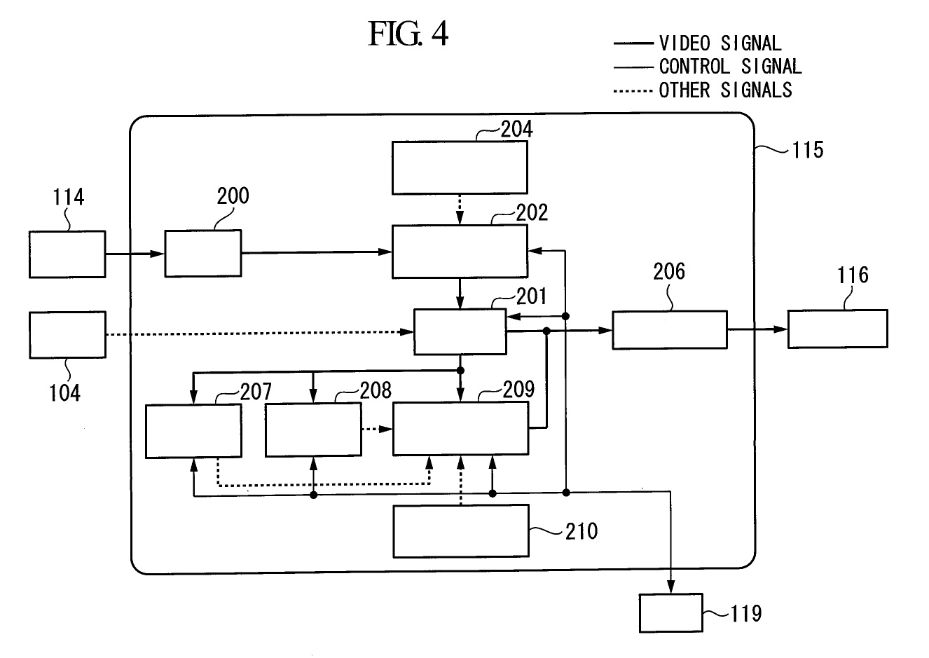

FIG. 4 shows a second configuration example of the color conversion section 115, in which the table conversion section 203 and the table coefficient ROM 205 shown in FIG. 3 are omitted, and a hue calculation section 207, a chroma calculation section 208, a nonlinear conversion section 209, and a nonlinear conversion coefficient ROM 210 are added. The basic configuration is the same as that of the color conversion section 115 shown in FIG. 3, and identical names and reference numerals are assigned to identical structures. The differences will be mainly described below.

In the color conversion section 115 shown in FIG. 4, the buffer 200 is connected to the linear matrix conversion section 202, and the linear matrix conversion section 202 is connected to the determination section 201. Furthermore, the linear matrix coefficient ROM 204 is connected to the linear matrix conversion section 202.

Furthermore, the determination section 201 is connected to the image buffer 206, the hue calculation section 207, the chroma calculation section 208, and the nonlinear conversion section 209. The hue calculation section 207 and the chroma calculation section 208 are connected to the nonlinear conversion section 209, and the nonlinear conversion section 209 is connected to the image buffer 206. Furthermore, the nonlinear conversion coefficient ROM 210 is connected to the nonlinear conversion section 209.

The control section 119 is bi-directionally connected to the determination section 201, the linear matrix conversion section 202, the hue calculation section 207, the chroma calculation section 208, and the nonlinear conversion section 209.

The YCbCr signals transferred from the WB section 114 are temporarily stored in the buffer 200 and are transferred to the linear matrix conversion section 202. The linear matrix conversion section 202 applies linear matrix conversion to the YCbCr signals of each pixel i that are obtained via the buffer 200, based on Equation (2).

In this way, the linear matrix conversion is applied to the YCbCr signals of all pixels, and the converted YCbCr′ signals are transferred to the determination section 201. The determination section 201 determines a color conversion processing method based on an ID number obtained via the memory 104. For example, the determination is performed by using Equation (4).

$$\{ \begin{matrix}if & ID = 1 method 1 \\ if & ID = 3 method 3\end{matrix} \qquad ( 4 )$$

wherein method3 indicates a color conversion processing method of further applying nonlinear conversion to the YCbCr′ signals to which the linear matrix conversion has been applied. When the ID number is 1, the YCbCr′ signals are transferred to the image buffer 206, and, when the ID number is 3, the YCbCr′ signals are transferred to the hue calculation section 207, the chroma calculation section 208, and the nonlinear conversion section 209. The hue calculation section 207 calculates a hue signal based on Equation (5).

Hᵢ=tan⁻¹(Cb′ᵢ/Cr′ᵢ) (5)

wherein Hᵢ indicates a hue signal of the pixel i, and Crᵢ′ and Cbᵢ′ indicate Cr and Cb signals of the pixel i that are obtained after the linear matrix conversion. Furthermore, Hᵢ falls within the range of values 0 to 359. The calculated hue signal is transferred to the nonlinear conversion section 209. The chroma calculation section 208 calculates a chroma signal based on Equation (6).

Cᵢ=\sqrt{Cr′ᵢ²+Cb′ᵢ²} (6)

wherein Cᵢ indicates a chroma signal of the pixel i. The calculated chroma signal is transferred to the nonlinear conversion section 209. The nonlinear conversion section 209 applies a color conversion process based on a nonlinear operation, only to YCbCr′ signals belonging to a predetermined particular color region that is defined in advance based on the hue signal and the chroma signal obtained via the hue calculation section 207 and the chroma calculation section 208. The nonlinear operation is performed using the following equations, for example.

Yᵢ″=q·Yᵢ′²+r·Cbᵢ′²+s·Crᵢ′²

Cbᵢ″=t·Yᵢ′²+u·Cbᵢ′²+v·Crᵢ′² (7)

Crᵢ″=w·Yᵢ′²+x·Cbᵢ′²+y·Crᵢ′²

wherein q to y indicate predetermined coefficients for the nonlinear operation. The nonlinear conversion coefficient ROM 210 previously records the coefficients q to y, and the nonlinear conversion section 209 reads the predetermined coefficients from the nonlinear conversion coefficient ROM 210 and performs the color conversion process based on the nonlinear operation.

Note that the color conversion process is performed based on the high-order nonlinear operation in the example described above; however, it is also possible to perform nonlinear matrix conversion that handles high-order terms of the Y, Cb, and Cr signals in addition to the linear matrix conversion shown in Equation (2), for example.

According to the endoscope apparatus of this embodiment, it is possible to select at least one of the linear matrix conversion section 202 and the nonlinear conversion section 209 based on an index obtained by the determination section 201 and to apply a color conversion process to an input video signal using the selected color conversion processing method. Furthermore, by selecting specific color conversion means based on the index previously set in each scope, a color conversion process appropriate for the characteristics of the scope can be performed.

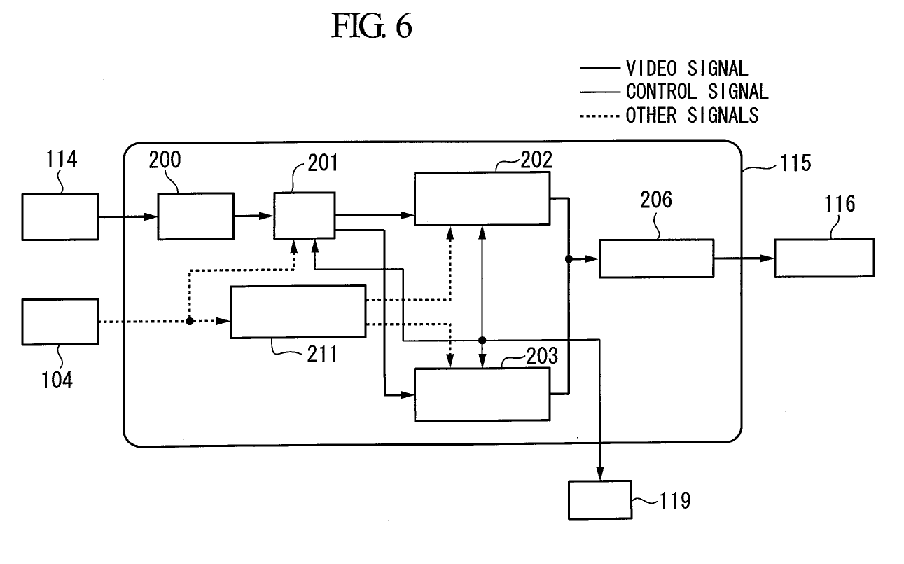

Note that, in the above-described configuration example, coefficients used for the color conversion processes are held in the ROMs in the processor; however, the present invention is not limited to this example, and a configuration such as that shown in FIG. 6 can also be used, for example. FIG. 6 shows a configuration in which the linear matrix coefficient ROM 204 and the table coefficient ROM 206 are omitted from the configuration diagram of the color conversion section 115 of FIG. 3. The basic configuration is the same as that of the color conversion section 115 shown in FIG. 3, and identical names and reference numerals are assigned to identical structures. The differences will be mainly described below.

The memory 104 is connected to a coefficient buffer 211. The coefficient buffer 211 is connected to the linear matrix conversion section 202 and the table conversion section 203.

The memory 104 previously records an ID number serving as the index for determining a color conversion processing method, and predetermined coefficients used for that color conversion processing method, for example, either linear matrix coefficients or table coefficients. The ID number recorded in the memory 104 is transferred to the determination section 201. The determination section 201 determines a color conversion processing method using Equation (1-1) based on the ID number obtained via the memory 104.

The determination section 201 transfers the YCbCr signals transferred from the buffer 200 to the linear matrix conversion section 202 when the ID number is 1, and transfers the YCbCr signals to the table conversion section 203 when the ID number is 2. The linear matrix conversion section 202 reads, for each pixel, the YCbCr signals transferred from the determination section 201 and performs linear matrix conversion shown in Equation (2). At this time, the linear matrix conversion section 202 reads predetermined linear matrix coefficients from the coefficient buffer 211 and performs linear matrix conversion. The table conversion section 203 reads, for each pixel, the YCbCr signals transferred from the determination section 201 and performs the color conversion process with reference to table coefficients recorded in the coefficient buffer 211 based on a combination of the YCbCr signals of each pixel. Whether to perform either the linear matrix conversion or the table conversion is determined depending on the model of each scope. The subsequent processes are the same as those described with reference to FIG. 3.

As described above, according to the endoscope apparatus of this configuration example, since it is unnecessary to provide the linear matrix coefficient ROM 204, the table coefficient ROM 206, and the nonlinear conversion coefficient ROM 210 in the color conversion section 115 by recording table coefficients for each scope in its memory 104, the storage capacity of the image processor can be reduced.

### Second Embodiment

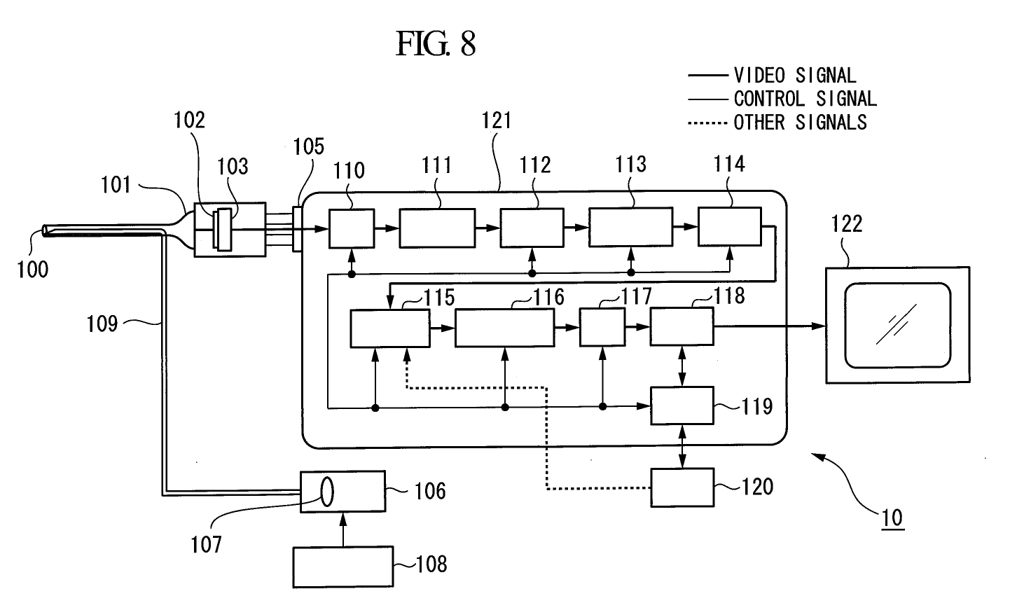

Next, a second embodiment of the present invention will be described by mainly using FIG. 8.

An image processor, an image acquisition unit, and an endoscope apparatus including the same according to this embodiment are different from those of the first embodiment in that an index for selecting at least one of the linear color conversion means and the nonlinear color conversion means is manually set by a user. For the endoscope apparatus according to this embodiment, the differences from the first embodiment will be mainly described, and a description of similarities will be omitted.

FIG. 8 is a functional block diagram showing, in expanded fashion, the functions of the endoscope apparatus according to this embodiment.

In this embodiment, a configuration in which the memory 104 is omitted from the configuration of the first embodiment is used. The basic configuration is the same as that of the first embodiment, and identical names and reference numerals are assigned to identical structures. The input section 120 is connected to the color conversion section 115.

The flow of a video signal in an endoscope apparatus 10 having the above-described configuration will be described below.

When the user operates the input section 120 and specifies a color mode and a model number for identifying the scope model, the specified color mode is transferred to the control section 119, and the specified model number is transferred to the color conversion section 115.

On the other hand, in the scope, the level of light from the light source is specified by the light-level control section 108, and a video of a subject is acquired by the scope. The video signal acquired by the scope is input to the processor main unit, is subjected to predetermined image processing, and is then input to the color conversion section 115. The determination section of the color conversion section 115 determines a color conversion processing method based on the model number input through the input section and performs a color conversion process using the determined color conversion processing method. The subsequent processes are performed in the same way as in the first embodiment.

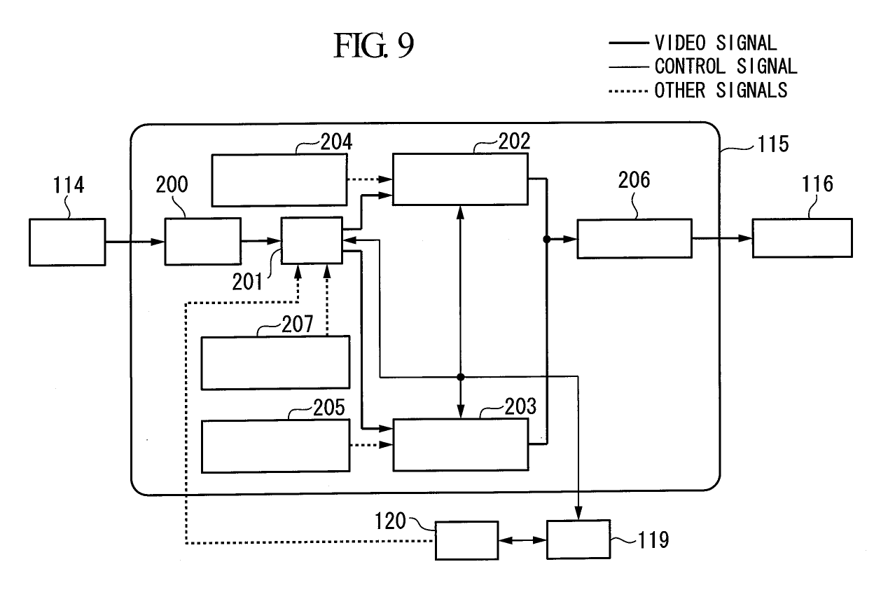

FIG. 9 shows a configuration example of the color conversion section 115, in which the memory 104 shown in FIG. 3 is omitted and a processing method table ROM 207 is added. The basic configuration is the same as that of the color conversion section 115 shown in FIG. 3, and identical names and reference numerals are assigned to identical structures.

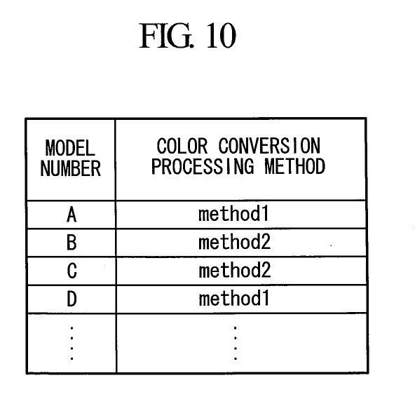

The processing method table ROM 207 is connected to the determination section 201. The control section 119 is bi-directionally connected to the input section 120. YCbCr signals transferred from the WB section 114 are temporarily stored in the buffer 200 and are transferred to the determination section 201. The determination section 201 determines a color conversion processing method with reference to a table coefficient recorded in the processing method table ROM 207 based on the model number of the scope obtained via the input section 120. As shown in FIG. 10, for example, the processing method table ROM 207 records table coefficients that describe the combinations of the model numbers of scopes and the color conversion processing methods corresponding thereto. The subsequent processes are performed in the same way as in the color conversion section 115 shown in FIG. 3.

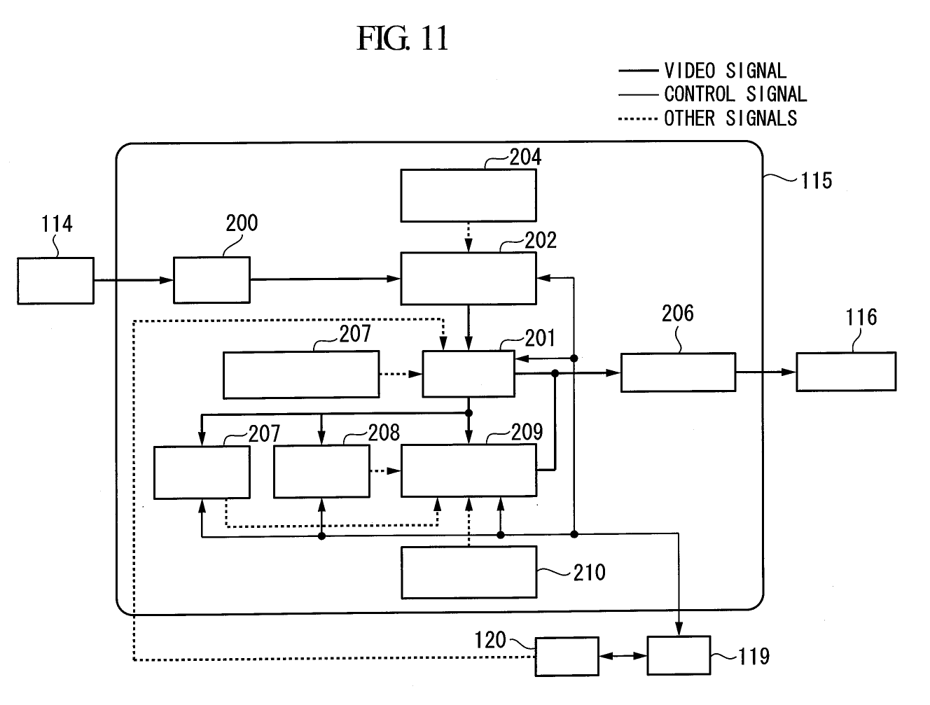

FIG. 11 shows a configuration example of the color conversion section 115, in which the memory 104 shown in FIG. 4 is omitted and the processing method table ROM 207 is added. The basic configuration is the same as that of the color conversion section 115 shown in FIG. 4, and identical names and reference numerals are assigned to identical structures.

The input section 120 is connected to the determination section 201. The processing method table ROM 207 is connected to the determination section 201. The control section 119 is bi-directionally connected to the input section 120. YCbCr signals that have been subjected to the linear matrix conversion in the linear matrix conversion section 202 are transferred to the determination section 201. The determination section 201 determines a color conversion processing method with reference to a table coefficient recorded in the processing method table ROM 207 based on the model number of the scope obtained via the input section 120. The subsequent processes are performed in the same way as in the color conversion section 115 shown in FIG. 4.

According to the image processor of this embodiment, since the user can specify a model number, even when a scope having no memory is used, a color conversion processing method suitable for the scope can be selected.

Note that, in the above-described configuration example, a color conversion processing method appropriate for the model number of a scope is determined by externally inputting the model number of the scope; however, the present invention is not limited to this example, and, for example, a configuration can also be used in which a menu listing model numbers is displayed on the display unit when a scope is connected to the processor section, and the user manually selects the model number of the scope from the menu.

The processing is performed by hardware in the respective embodiments described above; however, the present invention does not need to be limited to such a configuration, and a configuration in which the processing is performed by separate software can also be used.

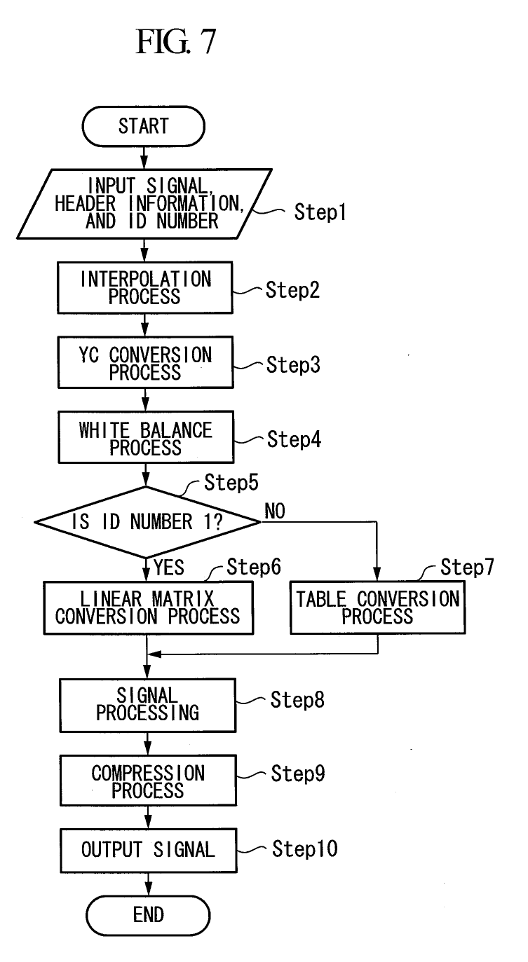

FIG. 7 shows a flow of software processing in the endoscope apparatus in the first embodiment.

In Step 1, an unprocessed video signal, an ID number for determining a color conversion processing method, and header information that includes accompanying information on image acquisition conditions, such as a white balance coefficient, are read. In Step 2, an interpolation process is performed to generate a four-plane video signal. In Step 3, the interpolated video signal obtained in Step 2 is converted into YCbCr signals. In Step 4, a white balance process is applied to the YCbCr signals. In Step 5, it is determined whether the ID number input in Step 1 is 1. If the ID number is 1, the flow advances to Step 6. If the ID number is not 1, the flow advances to Step 7. In Step 6, a color conversion process based on linear matrix conversion is applied to the YCbCr signals obtained in Step 5. In Step 7, a color conversion process based on table conversion is applied to the YCbCr signals obtained in Step 5. In Step 8, a known gradation conversion process, a known edge enhancement process, etc. are performed. In Step 9, a known compression process, e.g., JPEG is performed. In Step 10, the processed signals are output to a recording apparatus such as a hard disk and are recorded therein, and the process thus ends.

In the embodiments described above, the image acquisition system is a complementary single-plane CCD; the present invention is not limited to this, and, for example, a primary-color single-plane CCD or three-plane CCD can also be used. Further, the present invention can be applied not only to a CCD but also to a CMOS device.

Further, in the embodiments described above, a configuration is used in which one color conversion processing method is determined from two color conversion processing methods, as shown in FIGS. 3 and 4, for example; however, the present invention is not limited to this configuration and, for example, a configuration can also be used in which one color conversion processing method is selected from among three color conversion processing methods. In that case, a second determination section may be provided at the subsequent stage of the linear matrix conversion section 202 shown in FIG. 3. First, the determination section 201 determines whether to use a color conversion processing method based on table conversion. When it is determined to use a color conversion processing method based on linear matrix conversion, the second determination section provided at the subsequent stage of the linear matrix conversion section 202 determines whether to use a color conversion processing method based on nonlinear conversion.

Further, in the above-described embodiments, a description has been given of an example case where the scope is used as an image acquisition unit; however, the present invention is not limited to this example case. For example, in a case where a color conversion process is applied to a video signal acquired by a different model of digital camera or other cases, the above-described processor main unit may be used.

What is claimed is:

1. An image processor comprising:
a plurality of color conversion sections;
an information acquisition section that acquires an index for selecting at least one of the plurality of color conversion sections as a specific color conversion means for applying a color conversion process to an input video signal; and
a selection section that selects the at least one of the plurality of color conversion sections as the specific color conversion means, based on the index,
wherein the plurality of color conversion sections comprise a linear color conversion section that applies a color conversion process based on linear conversion to the input video signal and a nonlinear color conversion section that applies a color conversion process based on nonlinear conversion to the input video signal.

2. An image processor according to claim 1, wherein the index is previously specified in each image acquisition unit that outputs the input video signal.

3. An image processor according to claim 1, wherein:
the index is an ID number specified in an image acquisition unit that outputs the input video signal; and
the selection section has a table in which the ID number and a color conversion section to be selected are associated with each other and selects, by referring to the table, the color conversion section associated with the index as the specific color conversion means.

4. An image processor according to claim 1, further comprising an external interface,
wherein the information acquisition section acquires the index by reading the index recorded in a recording medium detachably connected to the external interface.

5. An image processor according to claim 1, wherein:
the index is recorded in a recording medium accommodated in a scope detachably attached to a main body; and
the information acquisition section reads the index from the recording medium while the scope is attached to the main body.

6. An image processor according to claim 4, wherein the recording medium records information required for the color conversion process.

7. An image processor according to claim 1, further comprising an input section that is used by a user to input the index,
wherein the information acquisition section acquires the index input through the input section.

8. An image processor according to claim 1, wherein the nonlinear color conversion section applies the color conversion process based on table conversion.

9. A scope that is detachably attached to an image processor according to claim 1 and that accommodates a recording medium having the index recorded therein.

10. An endoscope apparatus comprising:
an image processor according to claim 1; and
a scope according to claim 9.
